(19) United States
(12) Patent Application Publication
(10) Pub. No.: US 2015/0320099 A1
(43) Pub. Date: Nov. 12, 2015

(54) COMPOSITIONS AND METHODS FOR REDUCED CARBOHYDRATES AND INCREASED ERYTHRITOL IN BEVERAGES

(71) Applicants: THE COCA-COLA COMPANY, Atlanta, GA (US); CHR. HANSEN A/S, Hoersholm (DK)

(72) Inventors: Jeroen HUGENHOLTZ, Atlanta, GA (US); Thilo TRACHOTTA, Atlanta, GA (US); Martijn BEKKER, Atlanta, GA (US); Christel CARRIGUES, Frederiksberg C (DK)

(21) Appl. No.: 14/436,588

(22) PCT Filed: Oct. 17, 2013
(86) PCT No.: PCT/US13/65507

§ 371 Date: Apr. 17, 2015

Related U.S. Application Data
(60) Provisional application No. 61/715,130, filed on Oct. 17, 2012.
(60) Provisional application No. 61/715,134, filed on Oct. 17, 2012.

(51) Int. Cl. A23L 2/38; A23L 2/02; A23L 2/60

(52) U.S. Cl. CPC A23L 2/382; A23L 2/60; A23L 2/02; A23Y 2220/71; A23V 2002/00

(57) ABSTRACT

The present invention provides novel compositions and methods for naturally decreasing carbohydrates and calories, while increasing erythritol, in beverages. The method includes fermenting beverages, such as fruit juices with a microorganism capable of metabolizing sugars into sugar alcohol(s) such as erythritol, to produce a fermented beverage having reduced carbohydrates, and therefore reduced calories, and increased erythritol as compared to an unfermented equivalent beverage.

### CROSS-REFERENCE TO RELATED APPLICATIONS

This application claims the benefit of U.S. provisional applications 61/715,130 and 61/715,134, both filed Oct. 17, 2012, which are incorporated herein by reference in their entirety.

### FIELD OF THE INVENTION

The principles of the present invention relate generally to the field of beverage fermentation. In particular, compositions and methods for naturally metabolizing carbohydrates and producing erythritol in beverages, thus greatly reducing overall caloric content and the risk of intestinal problems for consumers with fructose malabsorption or intolerance, are provided by the principles of the present invention.

### BACKGROUND OF THE INVENTION

Approximately 30% of the population in Western countries are affected by malabsorption of carbohydrates, including fructose (Born, 2007). The only available treatment for patients suffering from fructose malabsorption or hereditary fructose intolerance is the appropriate monitoring of diet. Furthermore, the increasing incidence of obesity-related disease is often attributed to consumers making unhealthy food choices, especially with regard to the intake of food and drink that are high in sugars. New and improved formulations of beverages are desirable to meet changing market demands. In particular, there is considerable market demand for beverages having alternative nutritional characteristics such as reduced carbohydrate content. Therefore, development of new beverage formulations with satisfactory nutritional characteristics and flavor profiles represents an ongoing challenge for the beverage industry.

### SUMMARY OF THE INVENTION

In one aspect, the principles of the present invention provide a fermented beverage composition. In one embodiment, the fermented beverage includes reduced calories and increased erythritol relative to an unfermented equivalent beverage. In yet another embodiment, no exogenous erythritol is added to the fermented beverage.

In certain embodiments of the invention, the fermented beverage includes erythritol of approximately at least 0.5% by weight of the beverage. In one embodiment, the fermented beverage includes erythritol of up to about 10% by weight of the beverage.

In some embodiments of the invention, the fermented beverage includes from about 1%, about 2%, about 3%, about 5%, about 10%, about 15%, about 20%, about 25%, about 30%, about 35%, about 40%, to about 50% of the calories as compared to the unfermented equivalent beverage. In one embodiment of the invention, the fermented beverage includes reduced total carbohydrate by weight of the beverage. In certain embodiments of the invention, the carbohydrate is selected from the group consisting of glucose, fructose, maltose, galactose, maltodextrin, trehalose, fructo-oligosaccharides, and trioses.

In yet another embodiment of the invention, the fermented beverage is a fruit juice. In certain embodiments of the invention, the fruit juice is at least one selected from the group consisting of grapefruit, cherry, rhubarb, banana, passion fruit, lychee, grape, apple, orange, mango, plum, prune, cranberry, pineapple, peach, pear, apricot, blueberry, raspberry, strawberry, blackberry, huckleberry, boysenberry, mulberry, gooseberry, prairie berry, elderberry, loganberry, dewberry, pomegranate, papaya, lemon, lime, tangerine, passion fruit, kiwi, persimmon, currant, quince, and guava, or combinations thereof. It should be understood that additional and/or alternative fruit juices may be included.

In one embodiment of the invention, the fermented beverage includes from about 1%, about 2%, about 3%, about 5%, about 10%, about 15%, about 20%, about 25%, about 30%, about 35%, about 40%, about 50%, about 60%, about 65%, about 70%, about 75%, or about 80% by weight fruit juice.

In certain embodiments of the invention, the fermented beverage includes a non-nutritive sweetener. In some embodiments of the invention, the non-nutritive sweetener includes at least one selected from the group consisting of Stevia rebaudiana extract, stevioside, aspartame, saccharine, and sucralose. In one embodiment the non-nutritive sweetener is rebaudioside A (Reb A). In yet another embodiment of the invention, the fermented beverage includes a nutritive sweetener. In some embodiments of the invention, the nutritive sweetener includes at least one selected from the group consisting of sucrose, fructose, and glucose. In certain embodiments of the invention, the fermented beverage includes an additive selected from the group consisting of salts, food-grade acids, coloring agents, preservatives, ascorbic acid, energy-boosting agents, and vitamins.

In one embodiment of the invention, the fermented beverage includes ethanol from 0% to about 1% by weight of the beverage. In yet another embodiment of the invention, the fermented beverage does not contain ethanol.

In another aspect, the invention provides a method of producing a fermented beverage. In one embodiment of the invention, the method reduces calories and increases erythritol relative to an unfermented equivalent beverage. In some embodiments of the invention, the method includes fermenting a beverage with yeast capable of metabolizing sugars into erythritol. The method results in a fermented beverage having decreased caloric content and increased erythritol levels when compared to a non-fermented equivalent.

In certain embodiments of the invention, the method includes increasing the erythritol at least 0.5% by weight of the beverage as compared to an unfermented equivalent beverage. In one embodiment of the invention, the method includes producing a fermented beverage including erythritol of up to about 10% by weight of the beverage.

In some embodiments of the invention, the method includes producing a fermented beverage including from about 1%, about 2%, about 3%, about 5%, about 10%, about 15%, about 20%, about 25%, about 30%, about 35%, about 40%, to about 50% of the calories as compared to the unfermented equivalent beverage. In one embodiment of the invention, the method includes the step of reducing total carbohydrate by weight of the beverage. In certain embodiments of the invention, the method includes reducing total carbohydrate selected from the group consisting of glucose, fructose, maltose, galactose, maltodextrin, trehalose, fructo-oligosaccharides, and trioses.

In particular embodiments of the invention, the method includes the step of removing the yeast from the beverage. In certain embodiments of the invention, the method includes the step of removing the yeast from the beverage after fermentation.

In yet another embodiment of the invention, the method includes producing a fermented beverage including a fruit juice. In certain embodiments of the invention, the method includes producing a fermented beverage including a fruit juice from at least one of grapefruit, cherry, rhubarb, banana, passion fruit, lychee, grape, apple, orange, mango, plum, prune, cranberry, pineapple, peach, pear, apricot, blueberry, raspberry, strawberry, blackberry, huckleberry, boysenberry, mulberry, gooseberry, prairie berry, elderberry, loganberry, dewberry, pomegranate, papaya, lemon, line, tangerine, passion fruit, kiwi, persimmon, currant, quince, and guava, or combinations thereof.

In one embodiment of the invention, the method includes producing a fermented beverage including from about 1%, about 2%, about 3%, about 5%, about 10%, about 15%, about 20%, about 25%, about 30%, about 35%, about 40%, about 50%, about 60%, about 65%, about 70%, about 75%, or about 80% by weight fruit juice.

In certain embodiments of the invention, the method includes adding a non-nutritive sweetener. In some embodiments of the invention, the method includes adding a non-nutritive sweetener selected from the group consisting of Stevia rebaudiana extract, stevioside, aspartame, saccharine, and sucralose. In yet another embodiments of the invention, the method includes adding a nutritive sweetener. In some embodiments of the invention, the method includes adding a non-nutritive sweetener selected from the group consisting of sucrose, fructose, and glucose. In certain embodiments of the invention, the method includes adding an additive selected from the group consisting of salts, food-grade acids, coloring agents, preservatives, ascorbic acid, energy-boosting agents, and vitamins.

In yet another aspect, the invention provides a fermented beverage prepared by the method including the step of reducing calories and increasing erythritol relative to an unfermented equivalent beverage. In some embodiments, the invention provides a fermented beverage prepared by the method including the step of fermenting the beverage with yeast capable of metabolizing sugars into erythritol. In particular embodiments, the invention provides a fermented beverage prepared by the method including the step of decreasing caloric content of the beverage and increasing erythritol levels.

In an additional aspect, the invention provides a raw fermented juice. In one embodiment of the invention, the raw fermented juice includes reduced calories and increased erythritol relative to a non-fermented juice equivalent. In yet another embodiment of the invention, the raw fermented juice includes yeast capable of metabolizing at least one sugar to erythritol. In certain embodiments of the invention, the raw fermented juice includes at least 0.5% erythritol by weight of the juice. In certain embodiments of the invention, the raw fermented juice includes no exogenous erythritol added.

In one aspect, the principles of the present invention provide a raw fermented fruit juice composition. In one embodiment, the raw fermented fruit juice includes reduced fructose relative to an unfermented equivalent fruit juice. In another embodiment, the raw fermented fruit juice includes Lactobacillus reuteri. In yet another embodiment, the raw fermented fruit juice includes Oenococcus oeni.

In some embodiments, the raw fermented fruit juice includes from about 1%, about 2%, about 3%, about 5%, about 10%, about 15%, about 20%, about 25%, about 30%, about 35%, about 40%, about 50%, about 60%, about 70%, about 80%, about 90%, to about 95% or more of the fructose as compared to an unfermented equivalent fruit juice. In certain embodiments, the raw fermented fruit juice includes from about 90%, about 91%, about 92%, about 93%, about 94%, about 95%, about 96%, about 97%, about 98%, about 99% to about 100% of the glucose or sucrose as compared to an unfermented equivalent fruit juice.

In certain embodiments, the raw fermented fruit juice is at least one juice selected from the group consisting of grapefruit, cherry, rhubarb, banana, passion fruit, lychee, grape, apple, orange, mango, plum, prune, cranberry, pineapple, peach, pear, apricot, blueberry, raspberry, strawberry, blackberry, huckleberry, boysenberry, mulberry, gooseberry, prairie berry, elderberry, loganberry, dewberry, pomegranate, papaya, lemon, lime, tangerine, passion fruit, kiwi, persimmon, currant, quince, and guava, or combinations thereof. It should be understood that additional or alternative fruit juices may be included.

In another embodiment, the raw fermented fruit juice can be orange juice or mango juice including Lactobacillus reuteri. In yet another embodiment, the raw fermented fruit juice can be apple juice or grape juice including Oenococcus oeni.

In one embodiment, the raw fermented fruit juice includes from about 1%, about 2%, about 3%, about 5%, about 10%, about 15%, about 20%, about 25%, about 30%, about 35%, about 40%, about 50%, about 60%, about 65%, about 70%, about 75%, or about 80% by weight fruit juice.

In certain embodiments, the raw fermented fruit juice includes a non-nutritive sweetener. In some embodiments, the non-nutritive sweetener includes at least one selected from the group consisting of Stevia rebaudiana extract, stevioside, aspartame, saccharine, and sucralose. In one embodiment the non-nutritive sweetener is rebaudioside A (Reb A). In yet another embodiment, the raw fermented fruit juice includes a nutritive sweetener. In some embodiments, the nutritive sweetener includes at least one selected from the group consisting of sucrose and glucose. In certain embodiments, the raw fermented fruit juice includes an additive selected from the group consisting of salts, food-grade acids, coloring agents, preservatives, ascorbic acid, energy-boosting agents, and vitamins.

In another aspect, the principles of the present invention provide a method of producing a raw fermented fruit juice. In one embodiment, the method reduces fructose relative to an unfermented equivalent fruit juice. In some embodiments, the method includes fermenting a fruit juice with Lactobacillus reuteri or Oenococcus oeni. The method results in a raw fermented fruit juice having decreased fructose content when compared to an unfermented equivalent fruit juice.

In certain embodiments, the method includes producing a raw fermented fruit juice including from about 1%, about 2%, about 3%, about 5%, about 10%, about 15%, about 20%, about 25%, about 30%, about 35%, about 40%, about 50%, about 60%, about 70%, about 80%, about 90%, to about 95% or more of the fructose as compared to an unfermented equivalent fruit juice. In some embodiments, the method includes producing a raw fermented fruit juice including from about 90%, about 91%, about 92%, about 93%, about 94%, about 95%, about 96%, about 97%, about 98%, about 99%, to about 100% of the glucose or sucrose as compared to an unfermented equivalent fruit juice.

In particular embodiments, the method includes the step of removing the Lactobacillus reuteri or Oenococcus oeni from the fruit juice. In certain embodiments, the method includes the step of removing the Lactobacillus reuteri or Oenococcus oeni from the fruit juice after fermentation.

In certain embodiments, the method includes producing a raw fermented fruit juice including at least one juice selected from the group consisting of grapefruit, cherry, rhubarb, banana, passion fruit, lychee, grape, apple, orange, mango, plum, prune, cranberry, pineapple, peach, pear, apricot, blueberry, raspberry, strawberry, blackberry, huckleberry, boysenberry, mulberry, gooseberry, prairie berry, elderberry, loganberry, dewberry, pomegranate, papaya, lemon, line, tangerine, passion fruit, kiwi, persimmon, currant, quince, and guava, or combinations thereof.

In another embodiment, the method includes producing a raw fermented fruit juice including orange juice, or mango juice, including Lactobacillus reuteri. In yet another embodiment, the method includes producing a raw fermented fruit juice including apple juice, or grape juice, including Oenococcus oeni.

In one embodiment, the method includes producing a raw fermented fruit juice including from about 1%, about 2%, about 3%, about 5%, about 10%, about 15%, about 20%, about 25%, about 30%, about 35%, about 40%, about 50%, about 60%, about 65%, about 70%, about 75%, or about 80% by weight fruit juice.

In certain embodiments, the method includes adding a non-nutritive sweetener. In some embodiments, the method includes adding a non-nutritive sweetener selected from the group consisting of Stevia rebaudiana extract, stevioside, aspartame, saccharine, and sucralose. In one embodiment, the method includes adding the non-nutritive sweetener rebaudioside A (Reb A). In yet another embodiment, the method includes adding a nutritive sweetener. In some embodiments, the method includes adding a non-nutritive sweetener selected from the group consisting of sucrose and glucose. In certain embodiments, the method includes adding an additive selected from the group consisting of salts, food-grade acids, coloring agents, preservatives, ascorbic acid, energy-boosting agents, and vitamins.

In yet another aspect, the principles of the present invention provide a raw fermented fruit juice prepared by the method including the step of reducing fructose relative to an unfermented equivalent fruit juice. In some embodiments, the principles of the present invention provide a raw fermented fruit juice prepared by the method including the step of fermenting the fruit juice with Lactobacillus reuteri or Oenococcus oeni. In particular embodiments, the principles of the present invention provide a raw fermented fruit juice prepared by the method including the step of decreasing fructose content of the fruit juice.

These and other features, aspects, and advantages of the principles of the present invention will become better understood with reference to the following description and claims.

### BRIEF DESCRIPTION OF THE DRAWINGS

The accompanying drawings, which are incorporated in and form a part of the specification, illustrate the embodiments of the present invention and together with the description, serve to explain the principles of the invention.

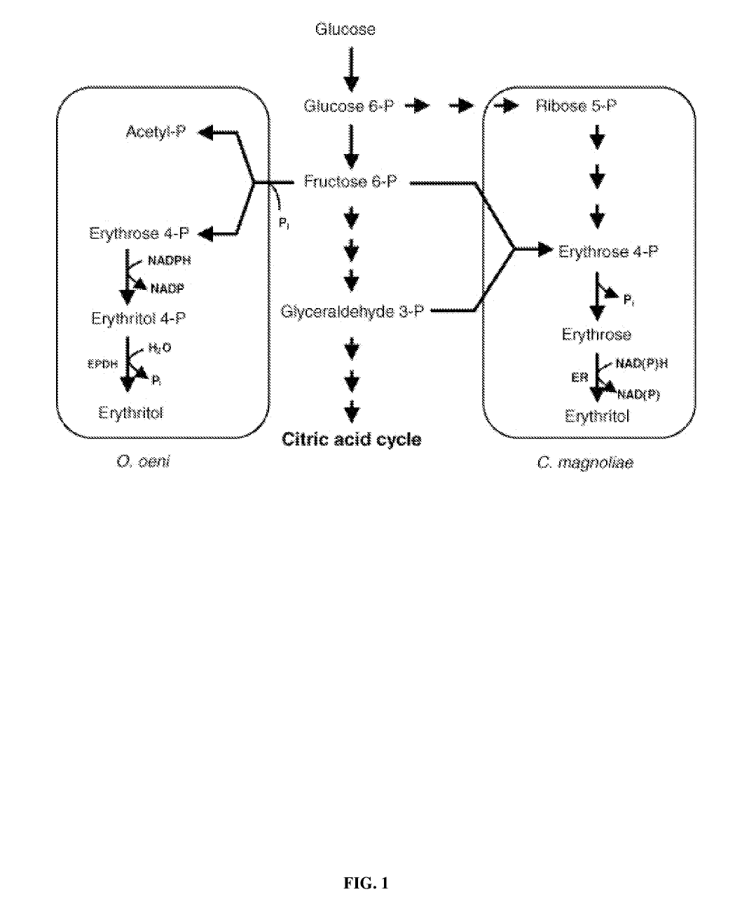

In the drawings, FIG. 1 illustrates the metabolic pathway for erythritol biosynthesis in fungi and bacteria.

### DETAILED DESCRIPTION OF THE INVENTION

The principles of the present invention are based at least in part on the surprising discovery that the carbohydrate content of beverages can be specifically and beneficially altered when fermented with certain microorganisms. In one aspect, beverages fermented with erythritol-producing microorganisms can naturally and significantly reduce the carbohydrate concentration of the beverage while increasing the erythritol concentration. In another aspect, fermenting beverages, such as fruit juices, with Lactobacillus reuteri or Oenococcus oeni, can naturally and significantly reduce the fructose concentration of the beverage while leaving other sugars (e.g., glucose and sucrose) relatively unchanged and without producing substantial quantities of alcohol. As a result, beverages are greatly reduced in calories and/or fructose, but exhibit little flavor change and partial maintenance of sweetness and mouth feel. Accordingly, the principles of the present invention provide fermented beverage compositions with reduced caloric content and increased erythritol, and/or reduced fructose content, as compared to an unfermented equivalent beverage.

As used herein, “fermented beverage” is generally a solution or a dispersion derived from or produced from a solution or dispersion containing at least one sugar as a substrate to be used by a microorganism. A typical example of such a fermented beverage can be fruit juice. In alternative embodiments, the fermented beverage is selected from grapefruit juice, cherry juice, rhubarb juice, banana juice, passion fruit juice, lychee juice, grape juice, apple juice, orange juice, mango juice, plum juice, prune juice, cranberry juice, pineapple juice, peach juice, pear juice, apricot juice, blueberry juice, raspberry juice, strawberry juice, blackberry juice, huckleberry juice, boysenberry juice, mulberry juice, gooseberry juice, prairie berry juice, elderberry juice, loganberry juice, dewberry juice, pomegranate juice, papaya juice, lemon juice, lime juice, tangerine juice, passion fruit juice, kiwi juice, persimmon juice, currant juice, quince juice, and guava juice, or combinations thereof.

As appreciated by one of skill in the art, water is a basic ingredient in the beverages disclosed here, typically being the primary liquid portion in which the remaining ingredients are dissolved, emulsified, suspended or dispersed. Those of ordinary skill in the art will understand that, for convenience, some ingredients are described herein by reference to the original form of the ingredient in which it is added to the beverage product formulation. Such original form may differ from the form in which the ingredient is found in the finished beverage product. For example, orange juice is generally made by extraction from the fresh fruit, by desiccation and subsequent reconstitution of dried juice, or by concentration of the juice and the subsequent addition of water to the concentrate. The beverage to be fermented, for instance, can be fresh, can be one containing pulp, or can be one from which pulp has been removed by centrifugation or filtration.

As used herein, “reduced calories” refers to a beverage having a reduction in calories as compared to the same volume of the standard calorie version, for instance the starting material prior to fermentation according to the methods herein or a previously commercialized standard calorie version of the beverage. In some embodiments, the beverage can have reduced calories from about 1%, about 2%, about 3%, about 5%, about 10%, about 15%, about 20%, about 25%, about 30%, about 35%, about 40%, about 50% to about 70% about 80%, about 90% or 95% or greater of the calories as compared to the unfermented equivalent beverage. As used herein, a “standard calorie” beverage formulation is one fully sweetened with a nutritive sweetener or endogenous carbohydrates. The “calorie” in the context of the present invention, also known as the large calorie, kilogram calorie, dietary calorie, nutritionist's calorie or food calorie, approximates the energy needed to increase the temperature of 1 kilogram of water by 1° C. This is approximately 1,000 small calories or about 4.2 kilojoules.

As used herein, “reduced fructose” refers to a beverage having a decreased concentration of fructose as compared to the same volume of an unfermented equivalent beverage, for instance the starting material prior to fermentation according to the methods herein. In some embodiments, the fermented beverage can have reduced fructose from about 1%, about 2%, about 3%, about 5%, about 10%, about 15%, about 20%, about 25%, about 30%, about 35%, about 40%, about 50% to about 70% about 80%, about 90% or 95% or greater of the fructose as compared to the unfermented equivalent beverage. It is appreciated that a reduced fructose beverage may also have lower calories than an unfermented equivalent beverage.

Erythritol (1,2,3,4-butanetetrol) (CAS Registry No. 149-32-6) (Formula: C₄H₁₀O₄) is a naturally occurring four-carbon sugar alcohol that has been approved for use in the United States and elsewhere. It has a sweetness about 60-80 percent that of sucrose and yet is only 10 percent of the calories. Erythritol is safe for tooth enamel, diabetics, and has little effect on blood sugar as it is rapidly excreted from the body without being metabolized.

As used herein, “increased erythritol” refers to a beverage having an increase in erythritol content by weight as compared to the same volume of the standard calorie version. In some embodiments, the fermented beverage can contain erythritol from about 0.1%, about 0.2%, about 0.3%, about 0.4%, about 0.5%, about 0.6%, about 0.7%, about 0.8%, about 0.9%, about 1.0%, about 1.5%, about 2.0%, about 3.0%, about 4.0%, about 5.0%, about 6.0%, about 7.0%, about 8.0%, about 9.0%, to about 10%, about 20%, or about 30% by weight of the beverage.

Fructose (also known as, for example, D-fructose, D-levulose, or D-arabino-2-hexulose) (CAS Registry No. 57-48-7) (Formula: C6H12O6) is a naturally occurring monosaccharide found in many plants. It has a sweetness about 1.73 times that of sucrose and is the sweetest of all the naturally occurring carbohydrates. Fructose is absorbed in the small intestine. Excess fructose can transit to the large intestine increasing osmotic load and act as a substrate for bacterial fermentation by normal gut flora. Symptoms of fructose malabsorption include, for example, bloating, flatulence, diarrhea or constipation, and stomach pain. Hereditary fructose intolerance is an autosomal recessive deficiency of the enzyme aldolase B. Dietary restriction of free fructose intake is the preferred treatment for symptom relief.

As used herein, “unfermented equivalent beverage” is a standard calorie version of a beverage or a beverage that has not undergone the fermentation process in accordance with the principles of the present invention.

As used herein, “fermentation” is the breakdown of organic substances by microorganisms to produce simpler organic compounds. While fermentation generally occurs under predominantly anaerobic conditions, it is not intended that the term be limited to strict anaerobic conditions, as fermentation also occurs in the presence of oxygen.

“Exogenous” with reference to a carbohydrate, sugar, or sugar alcohol, refers to a carbohydrate, sugar, or sugar alcohol that is added to a composition. It can be individually, selectively, and/or artificially supplemented to the composition.

“Endogenous” with reference to a carbohydrate, sugar, or sugar alcohol, refers to a carbohydrate, sugar, or sugar alcohol that occurs or is produced naturally in a food or beverage.

As used herein, a “non-nutritive sweetener” is one that does not provide significant caloric content in typical usage amounts, i.e., is one which imparts less than 5 calories per 8 ounce serving of beverage to achieve the sweetness equivalent of 10 Brix of sugar. In various embodiments, the fermented beverage composition further includes a non-nutritive sweetener selected from Stevia rebaudiana extract, stevioside, aspartame, saccharine, and sucralose. In one embodiment, the non-nutritive sweetener is rebaudioside A (Reb A).

As used herein, a “nutritive sweetener” is one that can provide significant caloric content in typical usage amounts, i.e., is one which imparts greater than 5 calories per 8 ounce serving of beverage to achieve the sweetness equivalent of 10 Brix of sugar. In various embodiments, the fermented beverage composition further includes a nutritive sweetener selected from sucrose, fructose, glucose, and high-fructose corn syrup.

As used herein, degrees Brix (° Bx) is the sugar content of an aqueous solution. One degree Brix is 1 gram of sucrose in 100 grams of solution and represents the strength of the solution as percentage by weight (% w/w).

As used herein, “reduced total carbohydrate” refers to at least a reduction in the carbohydrate content of a fermented beverage as compared to the standard calorie version. In certain embodiments, the reduced total carbohydrate is selected from glucose, fructose, maltose, galactose, maltodextrin, trehalose, fructo-oligosaccharides, and trioses. In other embodiments, the beverage can have reduced total carbohydrate from about 1%, about 5%, 10%, about 15%, about 20%, about 25%, about 30%, about 35%, about 40%, about 45%, about 50%, about 55%, about 60%, about 65%, about 70%, about 75%, about 80%, about 85%, about 90%, about 95%, about 99%, to about 100% of the carbohydrates as compared to the unfermented equivalent beverage.

It should be understood that beverages and other beverage products can have any of numerous different specific formulations or constitutions. In general, a beverage typically comprises at least water, acidulant, and flavoring. The beverage products in accordance with the principles of the present invention include beverages, i.e., ready to drink formulations, beverage concentrates, and the like. Juices suitable for use in at least some embodiments include, for example, fruit, vegetable, and berry juices. In beverages employing juice, juice may be used, for example, at a level from about 0.2%, about 0.5%, about 1%, about 2%, about 3%, about 5%, about 10%, about 15%, about 20%, about 25%, about 30%, about 35%, about 40%, about 50%, about 60%, about 70%, to about 80% by weight of the beverage.

Accordingly, the principles of the present invention provide a fermented beverage having a reduced total carbohydrate content and reduced calories with increased erythritol, or a fermented beverage having a reduced fructose content with no substantial change in other carbohydrates, as compared to a non-fermented equivalent beverage. Beverages, of which the taste profiles may be modified by the addition of sweeteners can be provided. Various beverages, contain sugars that may increase the calorie content of the product and thus make it a less preferred choice amongst consumers looking to maintain a healthy diet. Furthermore, various beverages, such as fruit juices, contain fructose that may overload the absorption capabilities of the digestive tract and thus make it a less preferred choice amongst consumers looking to avoid intestinal distress. In many instances, the calorie and/or fructose content of such beverages is reduced by diminishing or removing fructose alone, or all sugars, while at the same time preserving sweetness by adding artificial sweeteners. In many instances, the calorie content of such beverages is reduced by diminishing or removing all sugars while at the same time preserving sweetness by adding artificial sweeteners.

To prepare a fermented beverage composition of the present invention standard fermentation methods can be used. Examples of beverage fermentation can be found in U.S. Pat. Nos. 4,867,992 and 7,026,161; U.S. Publication No. 2009/0269438; EP 0166238; International Publication No. WO2012/036575; Chinese Patent Nos. 101864350 and 101864351, and Le Blanc et al., each of which is expressly incorporated herein by reference. Since propagation of the fermenting microorganism can utilize aerobic conditions, sufficient oxygen may be made available to the microorganisms in the propagation vessel(s) using techniques known in the art. Stirring or recirculation may suitably be employed to agitate the culture and keep the bacteria in suspension and/or continuously introduce air or oxygen into the fermenting beverage formulation. Propagation of fermenting bacteria can also proceed under anaerobic conditions whereby oxygen is depleted from the growth environment using known methodologies. As such, the principles of the present invention provide a method of producing a fermented beverage comprising incubating a beverage with a microorganism, such as a yeast capable of converting sugars into erythritol and/or a bacterium such as Lactobacillus reuteri or Oenococcus oeni capable of selectively catabolizing fructose, to produce a fermented beverage having reduced calories, and/or reduced carbohydrates along with increased erythritol, as compared to a non-fermented equivalent beverage. In one embodiment, fructose levels are reduced in the fermented beverage but other sugars, such as glucose or sucrose, are not substantially reduced.

While fructose removal by fermentation with yeast has been described previously, these methods did not provide for selective removal of fructose. For instance, in addition to removing fructose, multiple sugars were removed during the fermentation. Moreover, the product of the fermentation contained high alcohol content, in contrast to the present disclosure. Thus, one of the principles of the present invention provides for the selective reduction of fructose, without substantial production of alcohol, while retaining substantial levels of other sugars such as glucose and sucrose. Thus, to address the problems of completely removing all sugars and producing a beverage with a high alcohol content, one principle of the present invention makes use of Lactobacillus reuteri or Oenococcus oeni for naturally reducing the fructose content of beverages while maintaining glucose and sucrose content.

There are many known fructose-metabolizing microorganisms that find use in accordance with the principles of the present invention, some of which are bacteria such as, but not limited to, Lactobacillus reuteri and Oenococcus oeni. Eukaryotic microorganisms, like yeast, have also been known to metabolize fructose.

Additionally, at least one microorganism capable of fermenting sugars into erythritol may be used. Erythritol produced by fermentation is known in the art. However, to address the problem of using artificial sweeteners to create low-calorie beverages, one principle of the present invention makes use of erythritol-producing microorganisms for naturally reducing the calorie content of beverages by reducing the total carbohydrate concentration and increasing the erythritol concentration to maintain sweetness.

There are many known erythritol-producing microorganisms that find use in accordance with the principles of the present invention, most of which are yeasts that can tolerate high osmotic pressures, such as, but not limited to, Pichia, Yarrowia, Penicillium, Aspergillus, Candida, Torulopsis, Trigonopsis, Moniliella, Aureobasidium, and Trichosponon spp. Bacterial microorganisms have also been known to produce erythritol, such as Leuconostoc oenos GM. In one embodiment, the erythritol-producing organism is M. pollinis.

Erythritol is produced commercially by aerobic fermentation. Production of erythritol using Moniliella strains is discussed, for example, in U.S. Publication No. 2009/0246843. Strains of yeast capable of metabolizing sugars into erythritol can be found, for example, in Lin et al. Erythritol can also be produced by bacteria as, for example, discussed in Veiga-da-Cunha et al., and in fungi as, for example, discussed in Dijkema et al. The biosynthetic mechanisms of erythritol-production by microbes has been studied, for example, in Sawada et al. All references cited in this paragraph are expressly incorporated herein by reference.

As is conventional in the art, fermentation is achieved when microorganisms, such as the yeast M. pollinis or the bacteria Lactobacillus reuteri and Oenococcus oeni, are added to a medium (e.g., an unfermented beverage such as unfermented fruit juice), whereby the microorganisms catabolize sugars and/or convert sugars to alcohols. The production of erythritol and the catabolism of fructose in culture, as described herein, have been studied under aerobic conditions as discussed, for example, in Park et al. and Le Blanc et al., respectively, both of which are incorporated herein by reference.

Yeast capable of metabolizing sugars into erythritol typically grow and ferment in a pH range of about 3.0 to 5.0 whereas bacteria capable of metabolizing fructose typically grow and ferment in a pH range of about 2.0 to 7.0. The fermentation can be allowed to proceed spontaneously, or can be started by inoculation with a culture that has been previously fermented, in which case the unfermented beverage may be inoculated with populations of yeast or bacteria as is known in the art and may include, for instance, about 10⁶ to about 10⁷ cfu/ml juice. The fermentation process can, for example, extend from a few hours to greater than 1 or 2 or 3 or 4 or 5 or 6 or 7 or 8 or more days to a few weeks. To facilitate growth of the yeast, incubation can proceed at 20° C. to 30° C. with aeration. Similarly, to facilitate growth of the bacteria, incubation can proceed at 30° C. to 37° C. aerobically or anaerobically.

Thus, following fermentation, one principle of the present invention provides fermented beverage compositions with a reduced concentration of carbohydrates and increased the concentration of erythritol, which provides for overall reduction in calorie content of the beverage while maintaining sweetness. For example, fruit juices having a fructose, glucose, or sucrose concentration of less than 10%, 9%, 8%, 7%, 6%, 5%, 4%, 3%, 2%, and 1% by weight (% w/w) of the beverage may be provided. In addition, following fermentation, one principle of the present invention provides raw fermented fruit juice compositions with a reduced concentration of fructose as compared to a non-fermented equivalent fruit juice, which provides for improved gastrointestinal tolerability of the beverage while maintaining sweetness. For example, fruit juices having a fructose concentration of less than 50%, 45%, 40%, 35%, 30%, 25%, 20%, 15%, 10%, 5%, 3%, 2%, and 1% by weight (% w/w) of the beverage can be provided. In alternative embodiments, principles of the present invention can be used to provide reduced calories and/or reduced fructose in carbonated and non-carbonated soft drinks, fountain beverages, frozen ready-to-drink beverages, coffee beverages, tea beverages, dairy beverages, powdered soft drinks, as well as liquid concentrates, flavored waters, enhanced waters, fruit juice and fruit juice-flavored drinks, sports drinks, and alcoholic products. As appreciated by one of skill in the art, any of these beverages can be the starting material to be fermented according to the methods herein or are beverages to which fermented beverages can be added.

In one embodiment, the fermented beverage composition is a “raw fermented beverage.” As used herein, “raw” means not processed or purified. Natural embodiments of the beverage products disclosed herein are natural in that they do not contain anything artificial or synthetic. Therefore, as used herein, “natural” beverage composition is defined in accordance with the following guidelines: Raw materials for a natural ingredient exists or originates in nature. Biological synthesis involving fermentation and enzymes can be employed, but synthesis with chemical reagents is not utilized. Artificial colors, preservatives, and flavors are not considered natural ingredients.

Following fermentation one or more post-fermentation processing steps can be used such as pasteurization, filtration, centrifugation, or homogenization. For example, several pasteurization methods are commonly used (see, e.g., U.S. Pat. Nos. 4,830,862 and 4,925,686, incorporated herein by reference). One common method passes juice through a tube next to a plate heat exchanger, so the juice is heated without direct contact with the heating surface. Another method uses hot, pasteurized juice to preheat incoming unpasteurized juice. The preheated juice is further heated with steam or hot water to the pasteurization temperature. Typically, reaching a temperature of 185 to 201.2° F. (85-94° C.) for about 30 seconds is adequate to reduce the microbe count and prepare the juice for filling individual containers. Alternatively, typically at least about 20% of the microorganisms present in the fermented beverage are removed using one or more separators. Examples of separators that may be employed to remove the microorganism-containing residue from the fermented beverage include sedimenters, decanters, centrifuges, hydrocyclones, sieves, filters, membranes and presses. Accordingly, in one embodiment, the method includes a post-processing step of removing the microorganism capable of selectively fermenting fructose and/or the microorganism capable of fermenting sugars into erythritol. In some embodiments, the microorganisms can be removed from the fermentation reaction during fermentation, while in other embodiments, the microorganisms are removed following the completion of fermentation.

Ingredients can be processed or purified through certain specified techniques including at least: physical processes, fermentation, and enzymolysis. Appropriate processes and purification techniques include at least: absorption, adsorption, agglomeration, centrifugation, chopping, cooking (baking, flying, boiling, roasting), cooling, cutting, chromatography, coating, crystallization, digestion, drying (spray, freeze drying, vacuum), evaporation, distillation, electrophoresis, emulsification, encapsulation, extraction, extrusion, filtration, fermentation, grinding, infusion, maceration, microbiological (rennet, enzymes), mixing, peeling, percolation, refrigeration/freezing, squeezing, steeping, washing, heating, mixing, ion exchange, lyophilization, osmose, precipitation, salting out, sublimation, ultrasonic treatment, concentration, flocculation, homogenization, reconstitution, enzymolysis (using enzymes found in nature). Processing aids (currently defined as substances used as manufacturing aids to enhance the appeal or utility of a food component, including clarifying agents, catalysts, flocculants, filter aids, and crystallization inhibitors, etc. (see, 21 CPR §170.3(o)(24)), are incidental additives and can be used if removed appropriately.

Non-nutritive sweeteners, also called artificial sweeteners, or high-intensity sweeteners, are agents that exhibit a sweetness many times that of sucrose. Examples of high-intensity sweeteners include saccharin, cyclamate, aspartame, monatin, alitame, acesulfame potassium, sucralose, thaumatin, stevioside, glycerrhizin, sucralose, and neotame. Therefore, beverages such as fruit juice, sports drinks, and soft drinks, are sweetened with non-nutritive sweeteners that may not occur naturally in the source ingredients for the beverage and thus are generally regarded as undesirable by many consumers. By contrast, nutritive sweeteners generally refer to naturally occurring substances. Examples of nutritive sweeteners include glucose, fructose, maltose, galactose, maltodextrin, trehalose, fructo-oligosaccharides, and trioses. Due to the prevalence and popularity of non-nutritive sweeteners in beverages, several processes have been described for modifying the taste profile of beverages that contain these non-nutritive sweeteners.

As used herein, “additive” means food additive, or a substance added to food to preserve flavor or enhance its taste and appearance. In some embodiments, the fermented beverage composition further includes an additive selected from salts, food-grade acids, coloring agents, preservatives, ascorbic acid, energy-boosting agents, and vitamins. Further, it will generally be an option to add other ingredients to the formulation of a particular beverage embodiment, including flavorings, electrolytes, tastents, masking agents, flavor enhancers, carbonation, or caffeine.

Once made, the fermented beverage finds use as a beverage of its own or can be mixed with one or more other beverages. Carbon dioxide can be used to provide effervescence to certain embodiments of the beverages disclosed herein. Any of the techniques and carbonating equipment known in the art for carbonating beverages can be employed. Cola beverages, which typically exhibit a dark brown color derived from caramel coloring resulting from heat-treated carbohydrates, can also benefit from the reduced fructose method, and/or the reduced calorie and increased erythritol method, in accordance with the principles of the present invention.

Definitions and methods described herein are provided to better define the present disclosure and to guide those of ordinary skill in the art in the practice of the present disclosure. Unless otherwise noted, terms are to be understood according to conventional usage by those of ordinary skill in the relevant art.

In some embodiments, numbers expressing quantities of ingredients, properties such as molecular weight, reaction conditions, and so forth, used to describe and claim certain embodiments of the present disclosure are to be understood as being modified in some instances by the term “about.” In some embodiments, the term “about” is used to indicate that a value includes the standard deviation of the mean for the device or method being employed to determine the value. In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable. The numerical values presented in some embodiments of the present disclosure may contain certain errors necessarily resulting from the standard deviation found in their respective testing measurements. The recitation of ranges of values herein is merely intended to serve as a shorthand method of referring individually to each separate value falling within the range. Unless otherwise indicated herein, each individual value is incorporated into the specification as if it were individually recited herein.

In some embodiments, the terms “a” and “an” and “the” and similar references used in the context of describing a particular embodiment (especially in the context of certain of the following claims) can be construed to cover both the singular and the plural, unless specifically noted otherwise. In some embodiments, the term “or” as used herein, including the claims, is used to mean “and/or” unless explicitly indicated to refer to alternatives only or the alternatives are mutually exclusive.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability.

Having described the present disclosure in detail, it will be apparent that modifications, variations, and equivalent embodiments are possible without departing the scope of the present disclosure defined in the appended claims. Furthermore, it should be appreciated that all examples in the present disclosure are provided as non-limiting examples.

### EXAMPLES

The following non-limiting examples are provided to further illustrate the present disclosure. It should be appreciated by those of skill in the art that the techniques disclosed in the examples that follow represent approaches the inventors have found function well in the practice of the present disclosure, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the present disclosure.

### Example 1

### Erythritol Production

Strains—

Several yeast strains were obtained from the BCCM Belgian public strain collection. All strains were tested for growth on malt extract and apple juice and their ability to produce erythritol. Two strains showing the best results, Moniliella pollinis strain MUCL40570 and Trichosporoides strain MUCL 10190, were tested in further experiments

Juice Fermentations—

Initial fruit juice fermentations were conducted using commercial fruit juices that were pasteurized and did not contain any preservatives or other additives. 80 ml of the various juices was dispensed into sterile 250 ml Erlenmeyer flasks and shaken at room temperature for 8 days. The pasteurized juice was inoculated with a 1% volume of a 3-4 day culture of yeast grown in apple juice. At various times during fermentation, samples were taken and analyzed.

Controlled Fermentations—

To study the effect of several incubation conditions (aeration, pH), 6 Sartorius mini-fermentors were filled with 250 or 500 ml grape juice, inoculated with an active Moniliella pollinis culture and followed for 8 days with frequent sampling. Aeration regimes were varied by setting different air flows, different stirring rates and using two different culture volumes (250 and 500 ml).

Chemical Analysis

Sugars—

Utilization (sucrose, glucose, fructose) and production of sugars (fructose, mannitol, erythritol) was analyzed using High Performance Liquid Chromatography (HPLC). For separation of the sugars a GRACE Prevail Carbohydrate ES column (250 mm length, 4.6 mm ID) was used with 75% acetonitrile as eluent. Evaporative Light Scattering Detection (ELSD) was used for detection of the sugars eluting from the column

Organic Acids—

Production or conversion of organic acids was also analyzed using HPLC. Acetic acid, lactic acid, gluconic acid, succinic acid, propionic acid and citric acid, were separated using a Bio-Rad ion-exclusion Aminex HPX-87H HPLC-column (300 mm×7.8 mm) using 0.002 N sulfuric acid as eluent. UV absorption (210 nm) was used for detection and quantification of the separated organic acids.

Alcohol—

For ethanol-measurements in (fermented) fruit juices, an Anton Paar Alcolyzer Plus Beer was used.

Density—

For density measurements of the (fermented) fruit juices, an Anton Paar DMA 4500 was used. Both Anton Paar devices use infrared-light for detection.

### Example 2

Erythritol production by fermentation with M. pollinis (strain MUCL 40570) was assessed in various juices (Table 1). At three- and eight-days post-inoculation with a starter culture of yeast, fermented juices were analyzed for their carbohydrate, erythritol, and ethanol content. In comparison to fruit juices that were not inoculated with yeast (control), all juices tested showed a significant decrease in fructose, glucose, and sucrose levels over time. Further, the fermented fruit juices showed increased concentrations of erythritol and very little ethanol. Control samples were fruit juices incubated at the same temperature and for the same period of time as experimental samples but without inoculation with a yeast culture.

### Example 3

Erythritol production by fermentation with M. pollinis (strain MUCL 40570) was assessed in grape juice (Table 2). At three- and six-days post-inoculation with a starter culture of yeast, fermented grape juice samples were analyzed for their carbohydrate, erythritol, and ethanol content. In comparison to grape juice that was not inoculated with yeast (control), all fermented grape juice samples tested showed a significant decrease in fructose, glucose, and sucrose levels over time. Further, the fermented grape juice samples showed increased concentrations of erythritol and very little ethanol. Control samples were grape juice incubated at the same temperature and for the same period of time as experimental samples but without inoculation with a yeast culture.

### Example 4

Erythritol production by fermentation with different strains of M. pollinis was assessed in apple juice (Table 3). After cultures were allowed to ferment, apple juice samples were analyzed for their carbohydrate, erythritol, and ethanol content. Post-fermentation cultures showed a similar level of calorie reduction. However, each strain of M. pollinis varied in the amount of glucose and fructose metabolized, in addition to the amount of erythritol synthesized.

Samples were also analyzed for various organic acid metabolic products. In comparison to apple juice that was not inoculated with yeast (control), both strains of yeast produced similar post-fermentation organic acid profiles. Fermented samples showed a slightly decreased concentration of malic acid in addition to an increased concentration of succinic acid. No measurable ethanol was detected in fermented apple juice samples of either yeast strain. Control samples were apple juice incubated at the same temperature and for the same period of time as experimental samples but without inoculation with a yeast culture.

### Example 5

Erythritol production by fermentation with M. pollinis (strain MUCL 40570) was assessed in apple juice and grape juice (Table 4). At three- and six-days post-inoculation with a starter culture of yeast, fermented apple and grape juice samples were analyzed for their carbohydrate, erythritol, and ethanol content. In comparison to a juice of the same variety that was not inoculated with yeast (control), all fermented apple and grape juice samples tested showed a significant decrease in fructose, glucose, and sucrose levels over time. Further, the fermented apple and grape juice samples showed increased concentrations of erythritol as well as similar levels of calorie and total sugar reduction. Control samples were apple or grape juice incubated at the same temperature and for the same period of time as experimental samples but without inoculation with a yeast culture.

Samples were also analyzed for various organic acid metabolic products. In comparison to control juice samples that were not inoculated with yeast, both varieties of fruit juice showed similar post-fermentation organic acid profiles. Fermented samples showed a decreased concentration of malic acid and an increased concentration of succinic acid. No measurable ethanol was detected in fermented samples of either fruit juice.

### Example 6

Erythritol production by fermentation with M. pollinis (strain MUCL 40570) was assessed in orange juice and mango juice (Table 5). At four- and five-days post-inoculation with a starter culture of yeast, fermented orange and mango juice samples were analyzed for their carbohydrate, erythritol, and ethanol content. In comparison to a juice of the same variety that was not inoculated with yeast (control), all fermented orange and mango juice samples tested showed a significant decrease in fructose, glucose, and sucrose levels over time. Further, the fermented orange and mango juice samples showed increased concentrations of erythritol as well as significant levels of calorie and total sugar reduction. Control samples were orange or mango juice incubated at the same temperature and for the same period of time as experimental samples but without inoculation with a yeast culture.

Samples were also analyzed for various organic acid metabolic products. In comparison to control juice samples that were not inoculated with yeast, both varieties of fruit juice showed similar post-fermentation organic acid profiles. Fermented samples showed a decreased concentration of malic acid and no change to slight increases in both citric acid and succinic acid concentrations. No measurable ethanol was detected in fermented samples of either fruit juice with the exception of the highly concentrated mango juice sample.

### Example 7

### Fructose Reduction

Strains—

For orange juice and mango juice fermentations, Lactobacillus reuteri DSM20016 was used. For apple and grape juice fermentations several Oenococcus oeni strains and other lactic acid bacteria collected from fresh fruit were used.

Juice Fermentations—

All fruit juices were commercially available 100% pasteurized juice. Juices were poured directly from their respective packaging containers into sterile cups and bottles. Juices were inoculated 5% (v/v) with pre-grown cultures of the various lactic acid bacteria grown in rich laboratory medium (MRS), which is known to those of ordinary skill in the art. Lactobacillus reuteri cultures were incubated at 37° C. and all other cultures at 30° C. Incubations with Lactobacillus reuteri were typically 2-4 days and incubations with Oenococcus oeni were typically 6-10 days. Samples were taken regularly for sugar analysis.

Sugar Analysis—

All samples taken from juice fermentations were centrifuged and filtered to remove cells and fruit debris. Utilization (fructose) and production of sugars (mannitol) were analyzed in these samples using High Performance Liquid Chromatography (HPLC). For separation of the sugars a GRACE Prevail Carbohydrate ES column (250 mm length, 4.6 mm ID) was used with 75% acetonitrile as eluent. Evaporative Light Scattering Detection (ELSD) was used for detection of the sugars eluting from the column

TABLE 1
Erythritol production in various juices by Moniliella pollinis strain MUCL 40570.

| | °Bx | | Fructose | | Glucose | | Sucrose | |
|---|---|---|---|---|---|---|---|---|
| Sample | Control | Exp. | Control | Exp. | Control | Exp. | Control | Exp. |
| Grapefruit | 9.98 | 3 d: 5.19 | 1.65 | 3 d: 0.61 | 1.73 | 3 d: 0 | 2.17 | 3 d: 0 |
| | | 8 d: 2.90 | | 8 d: 0.07 | | 8 d: 0 | | 8 d: 0 |
| Am. | 14.07 | 3 d: 11.06 | 1.85 | 3 d: 1.52 | 0.52 | 3 d: 0.98 | 3.98 | 3 d: 0.86 |
| Cherry | | 8 d: 8.24 | | 8 d: 0.66 | | 8 d: 0.87 | | 8 d: 0 |
| Rhubarb | 10.54 | 3 d: 9.93 | 1.41 | 3 d: 1.26 | 1.49 | 3 d: 1.07 | 4.96 | 3 d: 4.04 |
| | | 8 d: 6.07 | | 8 d: 1.18 | | 8 d: 0.12 | | 8 d: 0 |
| Banana | 14.09 | 3 d: 12.23 | 1.30 | 3 d: 4.95 | 1.45 | 3 d: 3.56 | 8.30 | 3 d: 0 |
| | | 8 d: 11.32 | | 8 d: 3.46 | | 8 d: 0.66 | | 8 d: 0 |
| Passion | 14.42 | 3 d: 12.91 | 4.95 | 3 d: 3.39 | 5.37 | 3 d: 2.93 | 2.58 | 3 d: 1.00 |
| fruit | | 8 d: 9.50 | | 8 d: 1.68 | | 8 d: 0.40 | | 8 d: 0.04 |
| Lychee | 11.08 | 3 d: 9.85 | nc | 3 d: 1.40 | nc | 3 d: 0.94 | nc | 3 d: 2.53 |
| | | 8 d: nc | | 8 d: nc | | 8 d: nc | | 8 d: nc |

| | | | Total Sugar | | | | Calorie | |
|---|---|---|---|---|---|---|---|---|
| | Erythritol | | Reduction | | Ethanol | | Reduction | |
| Sample | Control | Exp. | Control | Exp. | Control | Exp. | Control | Exp. |
| Grapefruit | 0 | 3 d: 1.39 | 0 | 8 d: 71 | 0 | nc | 0 | 8 d: 98 |
| | | 8 d: 1.54 | | | | | | |
| Am. | 0 | 3 d: 1.49 | 0 | 3 d: 24 | 0 | 8 d: 0.20 | 0 | 3 d: 47 |
| Cherry | | 8 d: 5.78 | | | | | | |
| Rhubarb | 0 | 3 d: 0.04 | 0 | 8 d: 30 | 0 | 8 d: 0.20 | 0 | 8 d: 83 |
| | | 8 d: 4.20 | | | | | | |
| Banana | 0 | 3 d: 0.51 | 0 | 8 d: 27 | 0 | 8 d: 0.20 | 0 | 8 d: 63 |
| | | 8 d: 4.00 | | | | | | |
| Passion | 0 | 3 d: 0.23 | 0 | 8 d: 56 | 0 | 8 d: 0.20 | 0 | 8 d: 84 |
| fruit | | 8 d: 3.57 | | | | | | |
| Lychee | 0 | 3 d: 0.76 | 0 | nc | 0 | nc | 0 | nc |
| | | 8 d: nc | | | | | | |

Data expressed as percentages; where °Bx = degrees Brix; d = days of fermentation; and nc = not calculated.

TABLE 2
Erythritol production in grape juice by Moniliella pollinis strain MUCL 40570.

| | | | | | | Total Sugar | | Calorie |
|---|---|---|---|---|---|---|---|---|
| Sample | °Bx | Fructose | Glucose | Sucrose | Erythritol | Reduction | Ethanol | Reduction |
| Control | 22.30 | 11.25 | 11.46 | nc | 0 | nc | 0 | nc |
| Fermentation 1 | 3 d: 16.92 | 3 d: 7.48 | 3 d: 8.36 | nc | 3 d: 0.15 | nc | 3 d: 1.50 | nc |
| | 6 d: 13.34 | 6 d: 5.25 | 6 d: 5.84 | | 6 d: 1.46 | | 6 d: 2.20 | |
| Fermentation 2 | 3 d: 17.47 | 3 d: 8.36 | 3 d: 9.15 | nc | 3 d: 0.14 | nc | 3 d: 1.60 | nc |
| | 6 d: 14.42 | 6 d: 6.03 | 6 d: 6.65 | | 6 d: 1.68 | | 6 d: 1.70 | |
| Fermentation 3 | 3 d: 18.46 | 3 d: 9.15 | 3 d: 9.39 | nc | 3 d: 0.43 | nc | 3 d: 0.20 | nc |
| | 6 d: 17.99 | 6 d: 8.95 | 6 d: 7.52 | | 6 d: 1.38 | | 6 d: 0.04 | |
| Fermentation 4 | 3 d: 18.50 | 3 d: 9.31 | 3 d: 9.25 | nc | 3 d: 0.39 | nc | 3 d: 0.10 | nc |
| | 6 d: 17.31 | 6 d: 9.25 | 6 d: 7.62 | | 6 d: 1.03 | | 6 d: 0.51 | |
| Fermentation 5 | 3 d: 24.18 | 3 d: 12.63 | 3 d: 14.61 | nc | 3 d: 0.05 | nc | 3 d: 1.10 | nc |
| | 6 d: 20.18 | 6 d: 9.75 | 6 d: 12.25 | | 6 d: 0.59 | | 6 d: 2.34 | |
| Fermentation 6 | 3 d: 17.82 | 3 d: 8.37 | 3 d: 9.70 | nc | 3 d: 0.15 | nc | 3 d: 1.40 | nc |
| | 6 d: 15.04 | 6 d: 5.68 | 6 d: 7.27 | | 6 d: 1.56 | | 6 d: 1.80 | |

Data expressed as percentages; where °Bx = degrees Brix; d = days of fermentation; and nc = not calculated.

TABLE 3
Erythritol production in apple juice by yeast.

| | | | | | | Total Sugar | Metabolic | Calorie |
|---|---|---|---|---|---|---|---|---|
| Sample | °Bx | Fructose | Glucose | Sucrose | Erythritol | Reduction | Products | Reduction |
| Control | 7.49 | 5.91 | 1.94 | 0.76 | 0 | 0 | MA: 0.73 | 0 |
| | | | | | | | SA: 0.11 | |
| Fermentation | 7.16 | 4.23 | 0.26 | 0.13 | 0.53 | 40 | MA: 0.59 | 46 |
| (strain 10190) | | | | | | | SA: 0.35 | |
| | | | | | | | AA: 0.00 | |
| | | | | | | | EtOH: 0.00 | |
| Fermentation | 7.06 | 4.26 | 0.59 | 0.03 | 1.11 | 30.5 | MA: 0.58 | 43.5 |
| (strain 40570) | | | | | | | SA: 0.53 | |
| | | | | | | | AA: 0.00 | |
| | | | | | | | EtOH: 0.00 | |
| Dilution | 5.14 | 3.28 | 0.90 | 0.58 | 0 | 0 | nc | 0 |
| Control | | | | | | | | |
| Dilution | 4.93 | 1.72 | 0.00 | 0.00 | 0.33 | 57 | nc | 64 |
| Fermentation | | | | | | | | |
| (strain 10190) | | | | | | | | |
| Dilution | 4.94 | 1.82 | 0.17 | 0.00 | 0.76 | 42 | nc | 58 |
| Fermentation | | | | | | | | |
| (strain 40570) | | | | | | | | |

Data expressed as percentages; where °Bx = degrees Brix; nc = not calculated; MA = malic acid; SA = succinic acid; AA = acetic acid; and EtOH = ethanol.

TABLE 4
Erythritol production in apple juice and grape juice by Moniliella pollinis strain MUCL 40570.

| | | | | | | Total Sugar | Metabolic | Calorie |
|---|---|---|---|---|---|---|---|---|
| Sample | °Bx | Fructose | Glucose | Sucrose | Erythritol | Reduction | Products | Reduction |
| Apple Juice | 11.13 | 3 d: 5.54 | 3 d: 1.71 | 3 d: 0.73 | 0 | 0 | MA: 0.75 | 0 |
| Control | | 6 d: 6.20 | 6 d: 1.90 | 6 d: 0.70 | | | SA: 0.24 | |
| Apple Juice | 6 d: 10.11 | 3 d: 4.85 | 3 d: 1.09 | 3 d: 0.53 | 3 d: 0.21 | 3 d: 16 | SA: 0.63 | 3 d: 19 |
| Fermentation 1 | | 6 d: 5.04 | 6 d: 1.25 | 6 d: 0.15 | 6 d: 0.54 | 6 d: 21 | EtOH: 0.00 | 6 d: 27 |
| Apple Juice | 6 d: 7.79 | 3 d: 4.17 | 3 d: 0.56 | 3 d: 0.59 | 3 d: 0.44 | 3 d: 28 | SA: 0.67 | 3 d: 33 |
| Fermentation 2 | | 6 d: 3.56 | 6 d: 0.38 | 6 d: 0.03 | 6 d: 1.09 | 6 d: 43 | EtOH: 0.00 | 6 d: 55 |
| Grape Juice | 18.53 | 3 d: 9.20 | 3 d: 9.32 | 0 | 0 | 0 | MA: 0.39 | 0 |
| Control | | 6 d: 9.90 | 6 d: 9.40 | | | | SA: 0.12 | |
| Grape Juice | 6 d: 15.51 | 3 d: 8.06 | 3 d: 6.87 | 0 | 3 d: 0.34 | 3 d: 18 | SA: 0.71 | 3 d: 20 |
| Fermentation 1 | | 6 d: 8.28 | 6 d: 5.68 | | 6 d: 1.32 | 6 d: 21 | EtOH: 0.00 | 6 d: 28 |
| Grape Juice | 6 d: 14.48 | 3 d: 8.35 | 3 d: 7.47 | 0 | 3 d: 0.18 | 3 d: 14 | SA: 0.70 | 3 d: 15 |
| Fermentation 2 | | 6 d: 7.80 | 6 d: 4.50 | | 6 d: 1.66 | 6 d: 28 | EtOH: 0.00 | 6 d: 36 |

Data expressed as percentages; where °Bx = degrees Brix; d = days of fermentation; MA = malic acid; SA = succinic acid; and EtOH = ethanol.

TABLE 5
Erythritol production in orange juice and mango juice by Moniliella pollinis strain MUCL 40570.

| | | | | | | Total Sugar | Metabolic | Calorie |
|---|---|---|---|---|---|---|---|---|
| Sample | °Bx | Fructose | Glucose | Sucrose | Erythritol | Reduction | Products | Reduction |
| Orange Juice | 10.98 | 1.97 | 1.78 | 2.65 | 0 | 0 | CA: 1.27 | 0 |
| Control | | | | | | | MA: 0.27 | |
| Orange Juice | 4 d: 4.40 | 4 d: 0.00 | 4 d: 0.00 | 4 d: 0.00 | 4 d: 1.12 | 4 d: 82.5 | 4 d CA: 1.64 | 4 d: 100 |
| Fermentation | 5 d: 4.20 | 5 d: 0.00 | 5 d: 0.00 | 5 d: 0.00 | 5 d: 1.02 | 5 d: 85.0 | 5 d CA: 1.53 | 5 d: 100 |
| | | | | | | | EtOH: 0.00 | |
| Mango Juice 10Bx | 9.64 | 1.85 | 0.52 | 3.98 | 0 | 0 | CA: 0.31 | 0 |
| Control | | | | | | | SA: 2.29 | |
| Mango Juice 10Bx | 4 d: 6.24 | 4 d: 1.27 | 4 d: 0.16 | 4 d: 0.00 | 4 d: 1.93 | 4 d: 47.0 | 4 d CA: 0.57 | 4 d: 78 |
| Fermentation | 5 d: 5.90 | 5 d: 0.92 | 5 d: 0.04 | 5 d: 0.00 | 5 d: 2.01 | 5 d: 53.0 | 4 d SA: 2.55 | 5 d: 85 |
| | | | | | | | 5 d CA: 0.51 | |
| | | | | | | | 5 d: SA: 2.08 | |
| | | | | | | | EtOH: 0.00 | |
| Mango Juice 15Bx | 14.11 | 2.97 | 0.80 | 6.15 | 0 | 0 | CA: 0.43 | 0 |
| Control | | | | | | | SA: 3.23 | |
| Mango Juice 15Bx | 4 d: 6.64 | 4 d: 0.18 | 4 d: 0.00 | 4 d: 0.04 | 4 d: 1.74 | 4 d: 80.0 | 4 d CA: 0.50 | 4 d: 66 |
| Fermentation | 5 d: 6.45 | 5 d: 0.04 | 5 d: 0.00 | 5 d: 0.00 | 5 d: 2.10 | 5 d: 78.0 | 4 d SA: 4.44 | 5 d: 68 |
| | | | | | | | 5 d CA: 0.60 | |
| | | | | | | | 5 d: SA: 4.83 | |
| | | | | | | | EtOH: 4.20 | |

Data expressed as percentages; where Bx = degrees Brix; d = days of fermentation; CA = citric acid; MA = malic acid; SA = succinic acid; and EtOH = ethanol.

### REFERENCES

The following references, to the extent that they provide exemplary procedural or other details supplementary to those set forth herein, are specifically incorporated herein by reference.
U.S. Patent Publication No. 2004/0071680
U.S. Patent Publication No. 2006/0057247
U.S. Patent Publication No. 2006/0240148
U.S. Patent Publication No. 2007/0082316
U.S. Patent Publication No. 2008/0044531
U.S. Patent Publication No. 2008/0292768
U.S. Patent Publication No. 2009/0061047
U.S. Patent Publication No. 2009/0246843
U.S. Patent Publication No. 2010/0008652
U.S. Patent Publication No. 2010/0215738
U.S. Patent Publication No. 2011/0189148
U.S. Patent Publication No. 2011/0223248
U.S. Patent Publication No. 2011/0236480
U.S. Patent Publication No. 2011/0287072
U.S. Pat. No. 4,830,862
U.S. Pat. No. 4,925,686
U.S. Pat. No. 6,942,857
U.S. Pat. No. 7,026,161
World IP Organization Publication WO2004/014403
World IP Organization Publication WO2006/113027
World IP Organization Publication WO2008/136730
World IP Organization Publication WO2009/040750
World IP Organization Publication WO2010/008491
World IP Organization Publication WO2010/098822
World IP Organization Publication WO2011/137249
Chinese Patent No. 101864350
Chinese Patent No. 101864351
Le-Blanc et al., Genetics and Molecular Research, 3:432-440, 2004.
Born, World Journal of Gastroenterology, 13(43):5687-5691, 2007.
Lin et al., Process Biochemistry, 45:973-979, 2010.
Dijkema et al., FEM Microbiology Letters, 33:125-131, 1986.
Park et al., Journal of Fermentation and Bioengineering, 86(6):577-580, 1998.
Sawada et al., Journal of Bioscience and Bioengineering, 108(5):385-390.
Veiga-da-Cunha et al., Journal of Bacteriology, 175(13):3941-3948, 1993.

1. A fermented beverage composition comprising reduced calories and increased erythritol relative to an unfermented equivalent beverage, wherein no exogenous erythritol is added.

2. The composition of claim 1, wherein the fermented beverage comprises erythritol of at least 0.5% by weight of the beverage.

3. The composition of claim 1, wherein the fermented beverage comprises erythritol of up to about 10% by weight of the beverage.

4. The composition of claim 1, wherein the fermented beverage comprises from about 1% to about 50% of the calories as compared to the unfermented equivalent beverage.

5. The composition of claim 1, wherein the fermented beverage comprises reduced total carbohydrate by weight of the beverage as compared to an unfermented equivalent beverage.

6. The composition of claim 5, wherein the carbohydrate is selected from the group consisting of glucose, fructose, maltose, galactose, maltodextrin, trehalose, fructo-oligosaccharides, and trioses.

7. The composition of claim 1, wherein the fermented beverage is a fruit juice.

8. The composition of claim 7, wherein the fruit juice is juice from a fruit selected from the group consisting of grapefruit, cherry, rhubarb, banana, passion fruit, lychee, grape, apple, orange, mango, plum, prune, cranberry, pineapple, peach, pear, apricot, blueberry, raspberry, strawberry, blackberry, huckleberry, boysenberry, mulberry, gooseberry, prairie berry, elderberry, loganberry, dewberry, pomegranate, papaya, lemon, line, tangerine, passion fruit, kiwi, persimmon, currant, quince, and guava, or combinations thereof.

9. The composition of claim 1, wherein the fermented beverage comprises from about 1% to about 80% by weight fruit juice.

10. The composition of claim 1, comprising a non-nutritive sweetener.

11. The composition of claim 10, wherein the non-nutritive sweetener is selected from the group consisting of Stevia rebaudiana extract, stevioside, aspartame, saccharine, and sucralose.

12. The composition of claim 1, comprising a nutritive sweetener.

13. The composition of claim 12, wherein the nutritive sweetener is selected from the group consisting of sucrose, fructose, and glucose.

14. The composition of claim 1, comprising an additive selected from the group consisting of salts, food-grade acids, coloring agents, preservatives, ascorbic acid, energy-boosting agents, and vitamins.

15. The composition of claim 1, comprising ethanol from 0% to about 1% by weight of the beverage.

16. A method of producing a fermented beverage having reduced calories and increased erythritol relative to an unfermented equivalent beverage, comprising fermenting the beverage with a microorganism capable of metabolizing sugars into erythritol, the caloric content of the beverage decreasing and erythritol levels increasing.

17. The method of claim 16, wherein the fermented beverage comprises erythritol of:
a) at least about 0.5% by weight of the beverage; or
b) up to about 10% by weight of the beverage.

18. The method of claim 16, wherein the microorganism is a yeast.

19. The method of claim 18, wherein said yeast is Moniliella pollinis.

20. The method of claim 16, wherein the fermented beverage comprises from about 1% to about 50% of the calories as compared to the unfermented equivalent beverage.

21. The method of claim 16, wherein the fermented beverage comprises reduced total carbohydrate by weight of the beverage as compared to the unfermented equivalent beverage.

22. The method of claim 21, wherein the carbohydrate is selected from the group consisting of glucose, fructose, maltose, galactose, maltodextrin, trehalose, fructo-oligosaccharides, and trioses.

23. The method of claim 16, further comprising removing the yeast from the beverage.

24. The method of claim 16, wherein the fermented beverage is a fruit juice.

25. The method of claim 24, wherein the fruit juice is a juice from a fruit selected from the group consisting of grapefruit, cherry, rhubarb, banana, passion fruit, lychee, grape, apple, orange, mango, plum, prune, cranberry, pineapple, peach, pear, apricot, blueberry, raspberry, strawberry, blackberry, huckleberry, boysenberry, mulberry, gooseberry, prairie berry, elderberry, loganberry, dewberry, pomegranate, papaya, lemon, line, tangerine, passion fruit, kiwi, persimmon, currant, quince, and guava, or combinations thereof.

26. The method of claim 16, wherein the fermented beverage comprises from about 1% to about 80% by weight fruit juice.

27. The method of claim 16, further comprising adding a non-nutritive sweetener.

28. The method of claim 27, wherein the non-nutritive sweetener is selected from the group consisting of Stevia rebaudiana extract, stevioside, aspartame, saccharine, and sucralose.

29. The method of claim 16, further comprising adding a nutritive sweetener.

30. The method of claim 29, wherein the nutritive sweetener is selected from the group consisting of sucrose, fructose, and glucose.

31. The method of claim 16, further comprising adding an additive selected from the group consisting of salts, food-grade acids, coloring agents, preservatives, ascorbic acid, energy-boosting agents, and vitamins.

32. A composition prepared by the method of claim 16.

33. A raw fermented juice comprising:
reduced calories and increased erythritol relative to a non-fermented juice equivalent; and
yeast capable of metabolizing at least one sugar to erythritol.

34. The raw fermented juice of claim 33, wherein the erythritol by weight of the juice is at least 0.5%, and wherein no exogenous erythritol is added.

35. A raw fermented fruit juice composition comprising:
reduced fructose relative to an unfermented equivalent fruit juice; and
Lactobacillus reuteri or Oenococcus oeni.

36. The composition of claim 35, wherein the raw fermented fruit juice comprises from about 1% to about 50% of the fructose as compared to the unfermented equivalent fruit juice.

37. The composition of claim 35, wherein the raw fermented fruit juice comprises from about 90% to about 100% of the glucose or sucrose as compared to an unfermented equivalent fruit juice.

38. The composition of claim 35, wherein the raw fermented fruit juice is juice from a fruit selected from the group consisting of grapefruit, cherry, rhubarb, banana, passion fruit, lychee, grape, apple, orange, mango, plum, prune, cranberry, pineapple, peach, pear, apricot, blueberry, raspberry, strawberry, blackberry, huckleberry, boysenberry, mulberry, gooseberry, prairie berry, elderberry, loganberry, dewberry, pomegranate, papaya, lemon, line, tangerine, passion fruit, kiwi, persimmon, currant, quince, and guava, or combinations thereof.

39. The composition of claim 35, wherein the raw fermented fruit juice is orange juice or mango juice, said composition comprising a Lactobacillus reuteri.

40. The composition of claim 35, wherein the raw fermented fruit juice is apple juice or grape juice, said composition comprising Oenococcus oeni.

41. The composition of claim 35, wherein the raw fermented fruit juice comprises from about 1% to about 80% by weight fruit juice.

42. The composition of claim 35, comprising a non-nutritive sweetener.

43. The composition of claim 42, wherein the non-nutritive sweetener is selected from the group consisting of Stevia rebaudiana extract, stevioside, aspartame, saccharine, and sucralose.

44. The composition of claim 35, comprising a nutritive sweetener.

45. The composition of claim 44, wherein the nutritive sweetener is selected from the group consisting of sucrose and glucose.

46. The composition of claim 35, comprising an additive selected from the group consisting of salts, food-grade acids, coloring agents, preservatives, ascorbic acid, energy-boosting agents, and vitamins.

47. A method of producing a raw fermented fruit juice having reduced fructose relative to an unfermented equivalent fruit juice, comprising fermenting the beverage with Lactobacillus reuteri or Oenococcus oeni, wherein the fructose content of the fruit juice decreases.

48. The method of claim 47, wherein the raw fermented fruit juice comprises from about 1% to about 50% of the fructose as compared to the unfermented equivalent fruit juice.

49. The method of claim 47, wherein the raw fermented fruit juice comprises from about 90% to about 100% of the glucose or sucrose as compared to an unfermented equivalent fruit juice.

50. The method of claim 47, further comprising the step of removing the Lactobacillus reuteri from the raw fermented fruit juice.

51. The method of claim 47, further comprising the step of removing the Oenococcus oeni from the raw fermented fruit juice.

52. The method of claim 47, wherein the raw fermented fruit juice is a juice from a fruit selected from the group consisting of grapefruit, cherry, rhubarb, banana, passion fruit, lychee, grape, apple, orange, mango, plum, prune, cranberry, pineapple, peach, pear, apricot, blueberry, raspberry, strawberry, blackberry, huckleberry, boysenberry, mulberry, gooseberry, prairie berry, elderberry, loganberry, dewberry, pomegranate, papaya, lemon, line, tangerine, passion fruit, kiwi, persimmon, currant, quince, and guava, or combinations thereof.

53. The method of claim 47, wherein the raw fermented fruit juice comprises from about 1% to about 80% by weight fruit juice.

54. The method of claim 47, comprising the step of adding a non-nutritive sweetener.

55. The method of claim 54, wherein the non-nutritive sweetener is selected from the group consisting of Stevia rebaudiana extract, stevioside, aspartame, saccharine, and sucralose.

56. The method of claim 47, comprising the step of adding a nutritive sweetener.

57. The method of claim 56, wherein the nutritive sweetener is selected from the group consisting of sucrose and glucose.

58. The method of claim 47, further comprising the step of adding an additive selected from the group consisting of salts, food-grade acids, coloring agents, preservatives, ascorbic acid, energy-boosting agents, and vitamins.

59. A composition prepared by the method of claim 47.
